(19) United States
(12) Patent Application Publication
(10) Pub. No.: US 2026/0141074 A1
(43) Pub. Date: May 21, 2026

(54) BIOS SECURE BOOT CONFIGURATION MODIFICATION REPORTING SYSTEM

(71) Applicant: Dell Products L.P., Round Rock, TX (US)

(72) Inventors: Wei Liu, Austin, TX (US); William C. Munger, Round Rock, TX (US); Gong Wang, Bellevue, WA (US)

(21) Appl. No.: 18/954,655

(22) Filed: Nov. 21, 2024

(51) Int. Cl. G06F 21/57; G06F 9/4401; G06F 21/44

(52) U.S. Cl. CPC G06F 21/575; G06F 9/4403; G06F 21/44; G06F 2221/034

(57) ABSTRACT

A BIOS secure boot configuration modification reporting system includes a computing device housing a non-volatile memory subsystem coupled to a BIOS having a BIOS database that stores a secure boot configuration. During a current initialization of the computing device, the BIOS uses the secure boot configuration to generate a current initialization hash value, determines whether the current initialization hash value matches a previous initialization hash value in the non-volatile memory subsystem that was generated using the secure boot configuration during a previous initialization of the computing device and, if not, generates an unexpected secure boot configuration modification message. If the current initialization hash value matches the second initialization hash value, the BIOS determines that a BIOS image included in the BIOS provides a modification to component authentication information included in the secure boot configuration and, in response, generates an expected secure boot configuration modification message.

### BACKGROUND

The present disclosure relates generally to information handling systems, and more particularly to reporting modifications to a secure boot configuration for a BIOS in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, include a Basic Input/Output System (BIOS) that may be provided with a secure boot configuration that is utilized by the BIOS to securely boot or otherwise initialize the computing device. However, the secure boot configuration for the BIOS must occasionally be modified, which can raise some issues.

For example, the BIOS for many computing devices are using “old” secure boot certificates (e.g., MICROSOFT® WINDOWS® Production Certificate Authority (PCA) 2011 certificates, the MICROSOFT® Corporation Unified Extensible Firmware Interface (UEFI) Certificate Authority (CA) 2011 certificates, and the MICROSOFT® Corporation Key Exchange Key (KEK) (CA) certificates that will expire in 2026) in their secure boot configurations, and BIOS providers (e.g., computing device manufacturers) must perform a “certificate transition” secure boot configuration modification that updates the secure boot databases in the secure boot configuration for the BIOS in those computing devices (e.g., via a BIOS update) with “new” secure boot certificates (e.g., MICROSOFT® UEFI CA 2023 certificates and MICROSOFT® Corporation KEK 2K CA 2023 certificates) such that the secure boot configuration for the BIOS of those computing devices includes both the “old” and “new” secure boot certificates in order to support the secure boot of those computing devices with both “old” and “new” operating systems.

To provide another example, a system owner (e.g., a BIOS provider, a computing device user, an Information Technology (IT) administrator, etc.) may perform a “DBX update” secure boot configuration modification to update the secure boot databases in the secure boot configuration for the BIOS in computing devices in order to protect the computing device from evolving threats (e.g., a revoked signature database (also called the “DBX” database) in the secure boot configuration for the BIOS in a computing device may be updated with a signature that identifies a component and prevents that component from operating with the computing device).

In order to maintain the integrity of the secure boot configuration of the BIOS in computing devices, the BIOS detects modifications to the secure boot configuration between each boot of the computing device. For example, during a current boot of the computing device, the BIOS may perform a hashing operation on the secure boot configuration to generate a “current” hash value, and compare it to a “most recent” hash value generated via a performance of the hashing operation on the secure boot configuration during a “most recent” boot of the computing device, with a modification to the secure boot configuration detected if the “current” hash value does not match the “most recent” hash value. In response to detecting a modification to the secure boot configuration, the BIOS may generate a secure boot warning message that simply identifies the modification to the secure boot configuration (e.g. a “UEFI0074” warning that “The Secure Boot policy has been modified”) without any further information about that modification, and provide the secure boot warning message for display on a display device of the computing device, while also logging that warning message in a lifecycle log.

However, conventional BIOS perform the secure boot configuration modification detection discussed above following BIOS updates like those that update the secure boot configuration as described above, and inventors of the present disclosure have found that the displaying of the secure boot warning message described above in response to the “certificate transition” secure boot configuration modifications and “DBX update” secure boot configuration modifications described above results in increased customer support calls, frequent changes to the code and configuration of the BIOS by the BIOS development team (also referred to as “churn”), and other related issues, even in computing devices that do not enable secure boot in their BIOS.

Accordingly, it would be desirable to provide a BIOS secure boot modification system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a Basic Input/Output System (BIOS) engine that is configured, during a first initialization of the IHS, to: generate, using a secure boot configuration, a first initialization hash value; determine whether the first initialization hash value matches a second initialization hash value that is stored in a non-volatile memory subsystem coupled to the processing system and that was generated using the secure boot configuration during a second initialization of the IHS that was performed prior to the first initialization of the IHS; generate, in response to determining that the first initialization hash value does not match the second initialization hash value, an unexpected secure boot configuration modification message; determine, in response to determining that the first initialization hash value matches the second initialization hash value, that a BIOS image included in the BIOS provides a modification to component authentication information included in the secure boot configuration; and generate, in response to determining that the BIOS image provides a modification to component authentication information included in the secure boot configuration, an expected secure boot configuration modification message.

### BRIEF DESCRIPTION OF THE DRAWINGS

FIG. 1 is a schematic view illustrating an embodiment of an Information Handling System (IHS).

FIG. 2 is a schematic view illustrating an embodiment of computing device that may provide the BIOS secure boot configuration modification reporting system of the present disclosure.

FIG. 3 is a flow chart illustrating an embodiment of a method for reporting modifications to a secure boot configuration in a BIOS.

FIG. 4 is a schematic view illustrating an embodiment of the computing device of FIG. 2 operating during the method of FIG. 3.

FIG. 5 is a schematic view illustrating an embodiment of the computing device of FIG. 2 operating during the method of FIG. 3.

FIG. 6 is a schematic view illustrating an embodiment of the computing device of FIG. 2 operating during the method of FIG. 3.

FIG. 7 is a schematic view illustrating an embodiment of the computing device of FIG. 2 operating during the method of FIG. 3.

FIG. 8 is a schematic view illustrating an embodiment of the computing device of FIG. 2 operating during the method of FIG. 3.

FIG. 9 is a schematic view illustrating an embodiment of the computing device of FIG. 2 operating during the method of FIG. 3.

FIG. 10 is a schematic view illustrating an embodiment of the computing device of FIG. 2 operating during the method of FIG. 3.

FIG. 11 is a schematic view illustrating an embodiment of the computing device of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

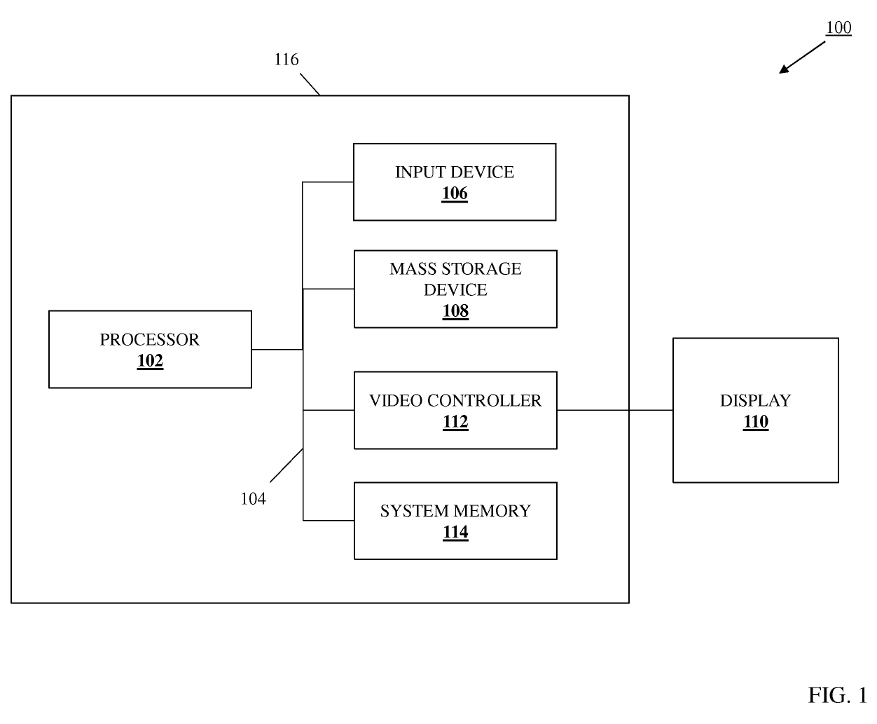

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

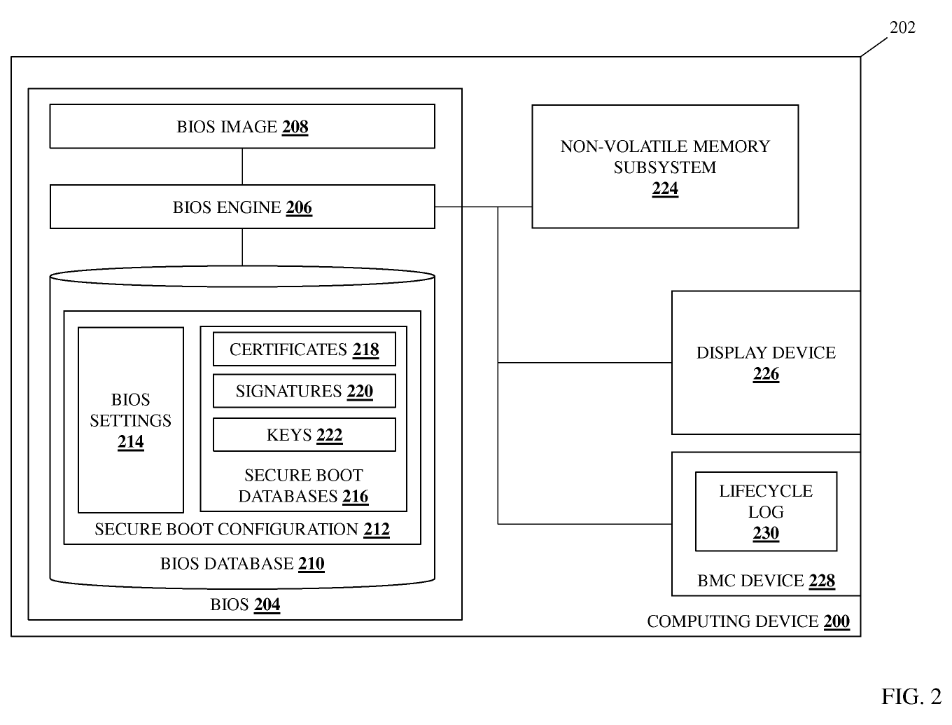

Referring now to FIG. 2, an embodiment of a computing device 200 is illustrated that may provide the BIOS secure boot modification reporting system of the present disclosure. In an embodiment, the computing device 200 may be provided by the IHS 100 discussed above with reference to FIG. 1, and/or may include some or all of the components of the IHS 100, and in specific examples may be provided by a server device. However, while illustrated and discussed as being provided by a server device, one of skill in the art in possession of the present disclosure will recognize that computing devices provided in the BIOS secure boot modification reporting system of the present disclosure may include laptop/notebook computing devices, desktop computing devices, tablet computing devices, mobile phones, networking devices (e.g., switch devices), storage systems, and/or any other computing devices that may be configured to operate similarly as the computing device 200 discussed below.

In the illustrated embodiment, the computing device 200 includes a chassis 202 that houses the components of the computing device 200, only some of which are illustrated and described below. For example, the chassis 202 may house a BIOS processing system (not illustrated, but which may be provided by BIOS processing firmware) and a BIOS memory system (not illustrated, but which may be provided by BIOS memory firmware such as, for example, a Serial Peripheral Interface (SPI) memory device) that is coupled to the BIOS processing system and that includes instructions that, when executed by the BIOS processing system, cause the BIOS processing system to provide a BIOS 204 that is configured to perform the functionality of the BIOS and/or computing devices discussed below. However, while illustrated and described as a “BIOS”, one of skill in the art in possession of the present disclosure will appreciate how the BIOS 204 and/or its components may be provided according to the UEFI specification that defines an architecture for firmware used to initialize computing device hardware and an interface for interacting with an operating system.

For example, the BIOS 204 may include a BIOS engine 206 that is configured to perform any of the BIOS secure boot modification reporting functionality that is described as being performed by the BIOS engines, BIOS subsystems, and/or BIOS described below. Furthermore, the BIOS 204 may also include a BIOS image 208 that includes a BIOS firmware volume and/or other data structures that store BIOS code and other BIOS information that is used by the BIOS processing system discussed above to provide the BIOS 204. As discussed below and as will be appreciated by one of skill in the art in possession of the present disclosure, the BIOS image 208 may be provided with BIOS updates that may be authenticated before they are performed to update the BIOS 204 as described below. Further still, the BIOS 204 may also include a BIOS storage subsystem (not illustrated, but which may be provided by BIOS storage firmware such as, for example, the SPI memory device discussed above) that is configured to provide a BIOS database 210 that may store any of the information used by the BIOS engine 206 as described below.

In the illustrated example, the BIOS database 210 stores a secure boot configuration 212 that includes a plurality of BIOS settings 214, as well as a plurality of secure boot databases 216. To provide a specific example, the plurality of secure boot databases 216 may be provided by an authorized signatures database (also called a “DB” database), a revoked signatures database (also called a “DBX” database), a Key Exchange Key (KEK) database, a Platform Key (PK) database, a timestamp database (also called a “DBT” database), and/or any other databases that would be apparent to one of skill in the art in possession of the present disclosure, any of which may be provided by secure boot Unified Extensible Firmware Interface (UEFI) variables. As illustrated in FIG. 2, any of the secure boot databases 216 may store certificates 218, signatures 220 (e.g., which may be provided by hash values or other signatures known in the art), keys, and/or other secure boot database information that would be apparent to one of skill in the art in possession of the present disclosure.

The chassis 202 also houses a non-volatile memory subsystem 224 that is illustrated and described as being coupled to the BIOS engine 206 in the BIOS 204 (e.g., via a coupling between the non-volatile memory subsystem 224 and the BIOS processing firmware discussed above), and while the non-volatile memory subsystem 224 is illustrated and discussed as being separate from the BIOS 204 (e.g., the non-volatile memory subsystem 224 may be provided by any non-volatile memory device housed in or coupled to the computing device 200), one of skill in the art in possession of the present disclosure will appreciate how the non-volatile memory subsystem 224 may be included in the BIOS 204 (e.g., the non-volatile memory subsystem 224 may be included in the SPI memory device discussed above) while remaining within the scope of the present disclosure as well.

In the illustrated embodiment, the chassis 202 also houses a display device 226 that is coupled to the BIOS engine 206 in the BIOS 204 (e.g., via a coupling between the display device 226 and the BIOS processing firmware discussed above), and while the display device 226 is illustrated and described as being housed in the chassis 202 (e.g., the display device 226 may be provided in a laptop/notebook computing device), the display device 226 may be coupled to the computing device 200 (e.g., the display device 226 may be an external display device coupled to a desktop computing device or as part of a separate management computing device that is coupled to a server device) while remaining within the scope of the present disclosure as well. As illustrated, the chassis 202 may also house a Baseboard Management Controller (BMC) device 228 that is coupled to the BIOS engine 206 in the BIOS 204 (e.g., via a coupling between the BMC device 228 and the BIOS processing firmware discussed above), and that includes a lifecycle log 230.

As will be appreciated by one of skill in the art in possession of the present disclosure, the BMC device 228 may be provided by an integrated DELL® Remote Access Controller (iDRAC) included in server devices available from DELL® Inc. of Round Rock, Texas, United States, and thus may be configured to provide Out-Of-Band (OOB) management for the computing device 200 using mostly separate resources from the computing device in order to provide a browser-based interface or Command-Line Interface (CLI) for managing and monitoring hardware in the computing device 200 (e.g., the BMC device 228 may be configured to manage the BIOS updates discussed above that may be provided in the BIOS image 208). However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the BIOS secure boot modification reporting functionality discussed below, while remaining within the scope of the present disclosure as well.

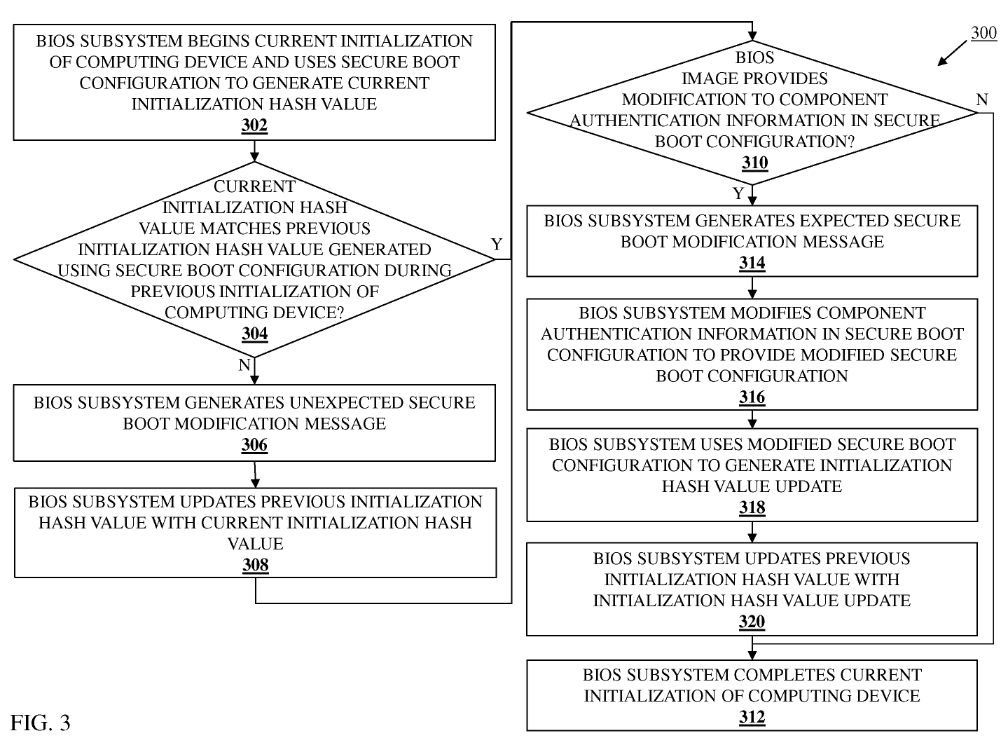

Referring now to FIG. 3, an embodiment of a method 300 for reporting modifications to a secure boot configuration in a Basic Input Output System (BIOS) is illustrated. As discussed below, the systems and methods of the present disclosure distinguish between expected and unexpected modifications to a secure boot configuration in a BIOS and generate an expected secure boot configuration modification message when expected modifications to the secure boot configuration are identified. For example, the BIOS secure boot configuration modification reporting system of the present disclosure may include a computing device housing a non-volatile memory subsystem coupled to a BIOS having a BIOS database that stores a secure boot configuration. During a current initialization of the computing device, the BIOS uses the secure boot configuration to generate a current initialization hash value, determines whether the current initialization hash value matches a previous initialization hash value in the non-volatile memory subsystem that was generated using the secure boot configuration during a previous initialization of the computing device and, if not, generates an unexpected secure boot configuration modification message. If the current initialization hash value matches the second initialization hash value, the BIOS determines that a BIOS image included in the BIOS provides a modification to component authentication information included in the secure boot configuration and, in response, generates an expected secure boot configuration modification message. As such, expected modifications to a secure boot configuration in a BIOS may be identified to users to reduce customer support calls, frequent changes to the code and configuration of the BIOS by the BIOS development team (also referred to as “churn”), and other related issues discussed above.

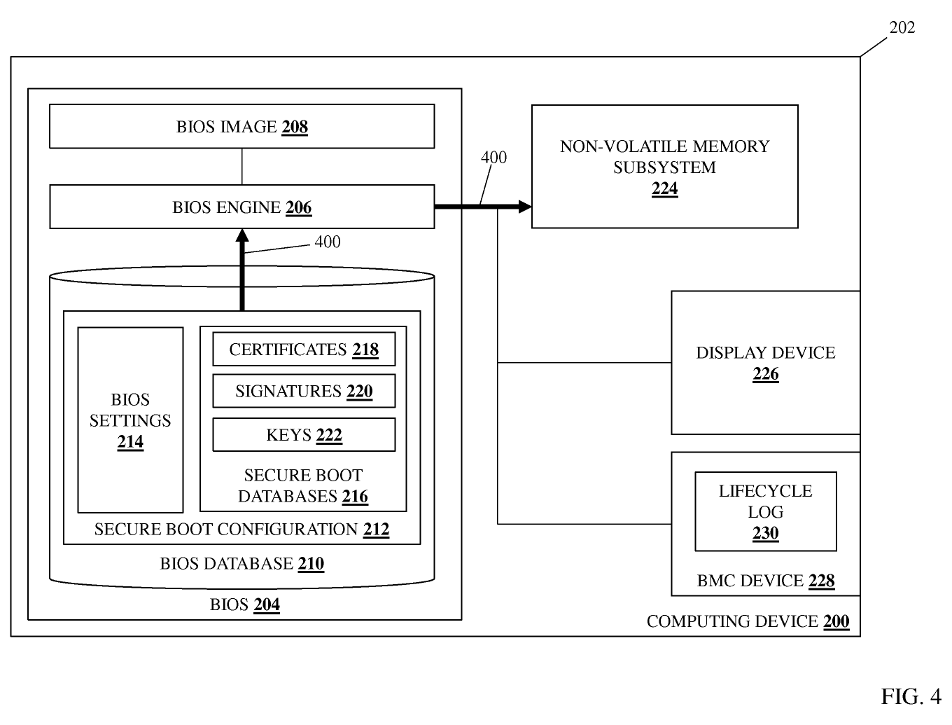

With reference to FIG. 4 and as will be recognized by one of skill in the art in possession of the present disclosure, prior to the “current” iteration of the method 300 discussed below and as part of a “previous” iteration of the method 300 that occurs during a “previous” initialization of the computing device 200, the BIOS engine 206 in the BIOS 204 may perform initialization hash value provisioning operations 400 that may include performing a hashing operation (e.g., a Secure Hash Algorithm (SHA) hashing operation and/or other hashing operations known in the art) using information stored in the secure boot configuration 212 to generate a “previous” initialization hash value for the secure boot configuration 221 during that “previous” initialization of the computing device 200, and storing that “previous” initialization hash value in the non-volatile memory subsystem 224. As such, one of skill in the art in possession of the present disclosure will appreciate how the “previous” initialization hash value for the secure boot configuration 212 during the “previous” initialization of the computing device 200 may be generated using information in the BIOS settings 214; the certificates 218, signatures 220, and keys 222 in the secure boot databases 216; and/or any other information that one of skill in the art in possession of the present disclosure will recognize may be included in the secure boot configuration 212.

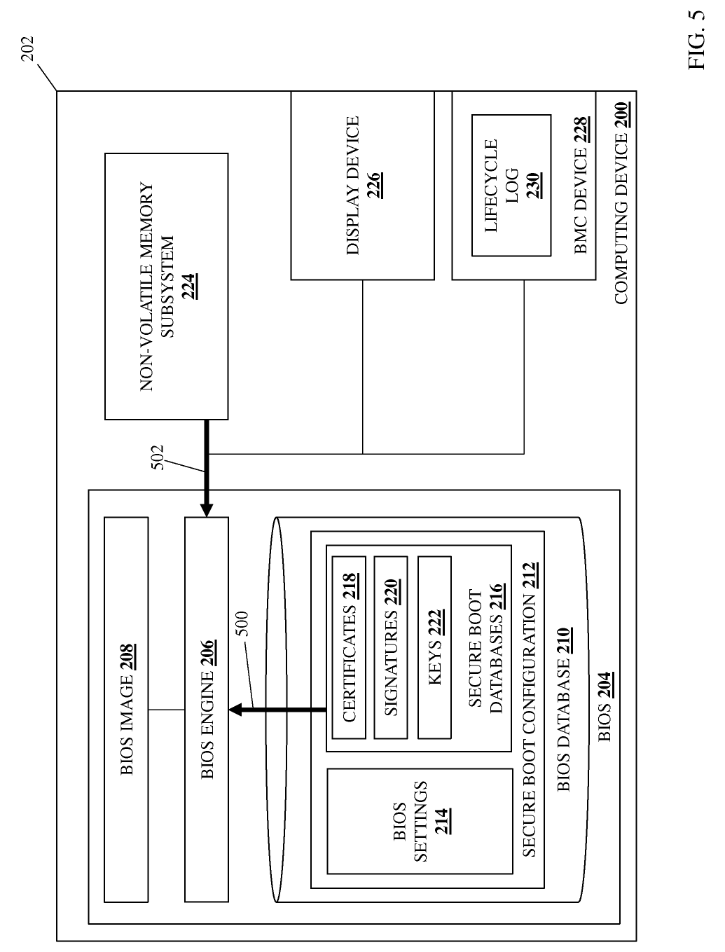

The method 300 begins at block 302 where a BIOS subsystem begins a current initialization of a computing device and uses a secure boot configuration to generate a current initialization hash value. In an embodiment, at block 302, the computing device 200 may be powered on, booted, reset, rebooted, and/or otherwise initialized and, in response, the BIOS 204 may begin a “current” initialization of the computing device 200. With reference to FIG. 5, in an embodiment of block 302 and as part of the “current” initialization of the computing device 200, the BIOS engine 206 in the BIOS 204 may perform initialization hash value generation operations 500 that may include performing a hashing operation (e.g., a SHA hashing operation and/or other hashing operations known in the art) using information stored in the secure boot configuration 212 to generate a “current” initialization hash value for the secure boot configuration 212 during that “current” initialization of the computing device 200. As such, one of skill in the art in possession of the present disclosure will appreciate how the “current” initialization hash value for the secure boot configuration 212 during the “current” initialization of the computing device 200 may be generated using information in the BIOS settings 214; the certificates 218, signatures 220, and keys 222 in the secure boot databases 216; and/or any other information that one of skill in the art in possession of the present disclosure will recognize may be included in the secure boot configuration 212.

The method 300 then proceeds to decision block 304 where the method 300 proceeds depending on whether the current initialization hash value matches a previous initialization hash value that was generated using the secure boot configuration during a previous initialization of the computing device. As discussed below, decision block 304 of the method 300 provides for a determination of whether an “unexpected” secure boot configuration modification has been made to the secure boot configuration 212 of the BIOS 204, and one of skill in the art in possession of the present disclosure will appreciate how decision block 304 is performed prior to the performance during the “current” initialization of the computing device 200 of any updates to that secure boot configuration 212 that may be provided by the BIOS image 208 (e.g., the BIOS updates that modify certificates, signatures, or other information in the secure boot databases 216 as described above) in order to ensure that any modifications detected to the secure boot configuration 212 at decision block 304 are not a result of an update provided by the BIOS image 208.

As will be appreciated by one of skill in the art in possession of the present disclosure, the hashing operation used to generate the “current” initialization hash value and the “previous” hash value discussed above will produce identical hash values when performed using identical information in the secure boot configuration 212 (i.e., when the information in the BIOS settings 214; the certificates 218, signatures 220, and keys 222 in the secure boot databases 216; and/or any other information included in the secure boot configuration 212 is not modified between the “previous” initialization and the “current” initialization of the computing device 200).

As such, one of skill in the art in possession of the present disclosure will also appreciate how the hashing operation used to generate the “current” initialization hash value and the “previous” hash value discussed above will produce different hash values when performed using different information in the secure boot configuration 212 (i.e., when the information in the BIOS settings 214; the certificates 218, signatures 220, and keys 222 in the secure boot databases 216; and/or any other information included in the secure boot configuration 212 is modified between the “previous” initialization and the “current” initialization of the computing device). As such, with continued reference to FIG. 5, in an embodiment of decision block 304, the BIOS engine 206 in the BIOS 204 may perform initialization hash value comparison operations 502 that include retrieving the “previous” initialization hash value from the non-volatile memory subsystem 224, and comparing the “current” initialization hash value to that “previous” initialization hash value. However, while the use of hash values to detect changes in the secure boot configuration have been described, one of skill in the art in possession of the present disclosure will appreciate how other techniques for detecting changes in the secure boot configuration will fall within the scope of the present disclosure as well.

If, at decision block 304, the current initialization hash value does not match the previous initialization hash value, the method 300 proceeds to block 306 where the BIOS subsystem generates an unexpected secure boot configuration modification message. In an embodiment, at decision block 304, the initialization hash value comparison operations 502 may include comparing the “current” initialization hash value to the “previous” initialization hash value and determining that the “current” initialization hash value does not match the “previous” initialization hash value. As discussed above and as will be appreciated by one of skill in the art in possession of the present disclosure, any difference between the “current” initialization hash value and the “previous” initialization hash value is indicative of a modification of information in the secure boot configuration (i.e., a modification of the information in the BIOS settings 214; a modification of the certificates 218, signatures 220, and keys 222 in the secure boot databases 216; and/or a modification of any other information included in the secure boot configuration 212) between the “previous” initialization and the “current” initialization of the computing device 200.

As discussed below, any “expected” secure boot configuration modifications that may be provided by BIOS updates and/or other information provided in a BIOS firmware volume included in the BIOS image 208 will not be made to the secure boot configuration 212 prior to the generation of the “current” initialization hash value, and thus the modification of the information in the secure boot configuration 212 identified when the “current” initialization hash value does not match the “previous” initialization hash value provides an “unexpected” secure boot configuration modification that may be an unauthorized modification to the secure boot configuration 212 (e.g., an unauthorized modification performed by an unauthorized user that has gained unauthorized access to the secure boot databases 216 (e.g., via an operating system running on the computing device 200 prior to the “current” initialization of the computing device 200)).

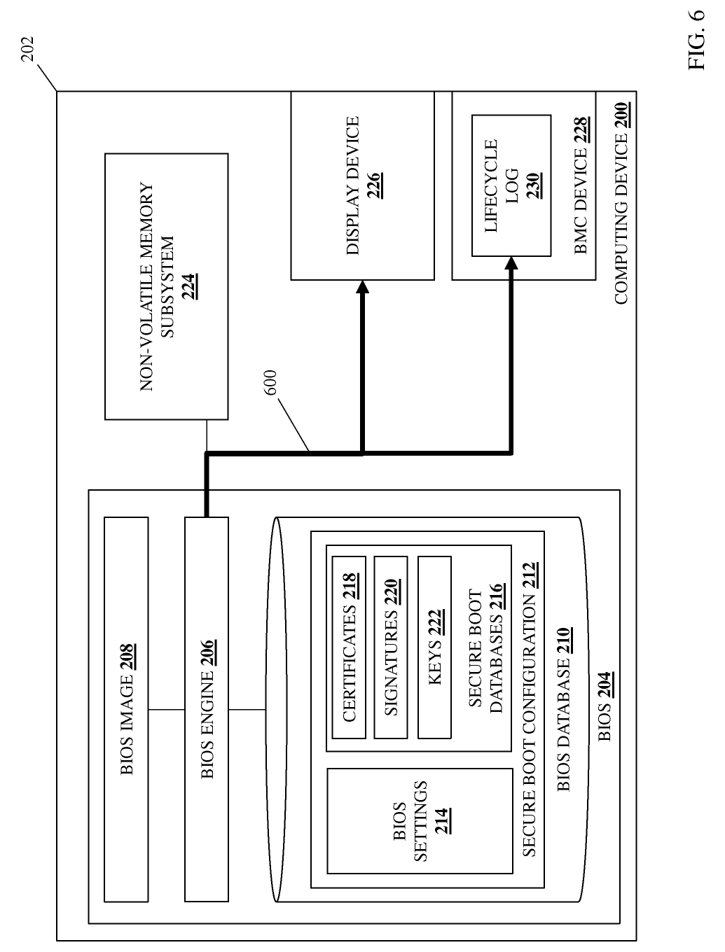

As such, with reference to FIG. 6 and in an embodiment of block 306, the BIOS engine 208 in the BIOS 204 may perform “unexpected” secure boot configuration modification message generation operations 600 that may include generating an “unexpected” secure boot configuration modification message that may be displayed on the display device 226, provided in the lifecycle log 230 included in the BMC device 228, and/or transmitted to a network administrator or other user using any techniques that would be apparent to one of skill in the art in possession of the present disclosure. In a specific example, the “unexpected” secure boot configuration modification message may be provided by a “UEFI0074” warning message (e.g., “The Secure Boot policy has been modified”), although one of skill in the art in possession of the present disclosure will appreciate how other “unexpected” secure boot configuration modification messages will fall within the scope of the present disclosure as well.

As will be appreciated by one of skill in the art in possession of the present disclosure, the “unexpected” secure boot configuration modification message generated at block 306 may be relatively alarming to a network administrator or other user, particularly if that network administrator or other user did not perform that “unexpected” secure boot configuration modification to the secure boot configuration 212, and may result in the customer support calls discussed above. However, one of skill in the art in possession of the present disclosure will recognize that the possibility that the “unexpected” secure boot configuration modification is an unauthorized modification to the secure boot configuration as described above warrants such actions.

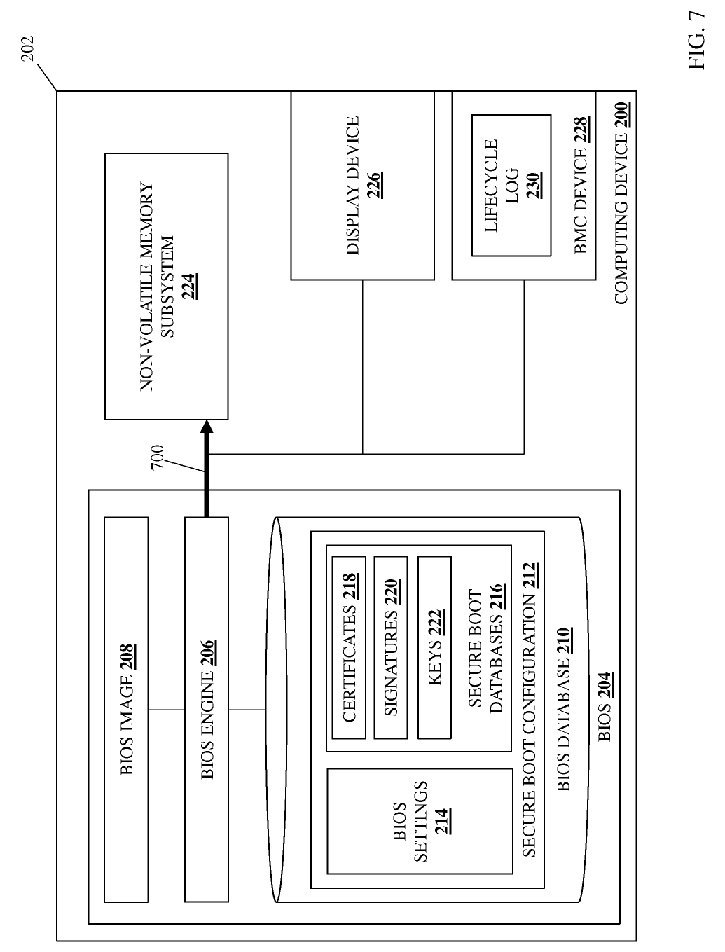

The method 300 then proceeds to block 308 where the BIOS subsystem updates the previous initialization hash value with the current initialization hash value. With reference to FIG. 7, in an embodiment of block 308, the BIOS engine 206 may perform initialization hash value update operations 700 that include storing the “current” initialization hash value generated at block 302 in the non-volatile memory subsystem 224 in place of the “previous” initialization hash value discussed above (i.e., deleting the “previous” initialization hash value from the non-volatile memory subsystem 224, and storing the “current” initialization hash value generated at block 302 in its place in the non-volatile memory subsystem 224). As will be appreciated by one of skill in the art in possession of the present disclosure, the “current” initialization hash value may then become the “previous” initialization hash value such that it may be utilized similarly as discussed above in a subsequent iteration of the method 300 and during a subsequent initialization of the computing device 200.

If at decision block 304 the current initialization hash value matches the previous initialization hash value, or following block 308, the method 300 proceeds to decision block 310 where the method 300 proceeds depending on whether a BIOS image provides a modification to component authentication information in the secure boot configuration. In an embodiment, at decision block 304, the initialization hash value comparison operations 502 may include comparing the “current” initialization hash value to the “previous” initialization hash value and determining that the “current” initialization hash value matches the “previous” initialization hash value. As discussed above and as will be appreciated by one of skill in the art in possession of the present disclosure, the matching of the “current” initialization hash value and the “previous” initialization hash value is indicative that there have been no modifications of information in the secure boot configuration (i.e., the information in the BIOS settings 214; the certificates 218, signatures 220, and keys 222 in the secure boot databases 216; and/or any other information included in the secure boot configuration 212) between the “previous” initialization and the “current” initialization of the computing device 200.

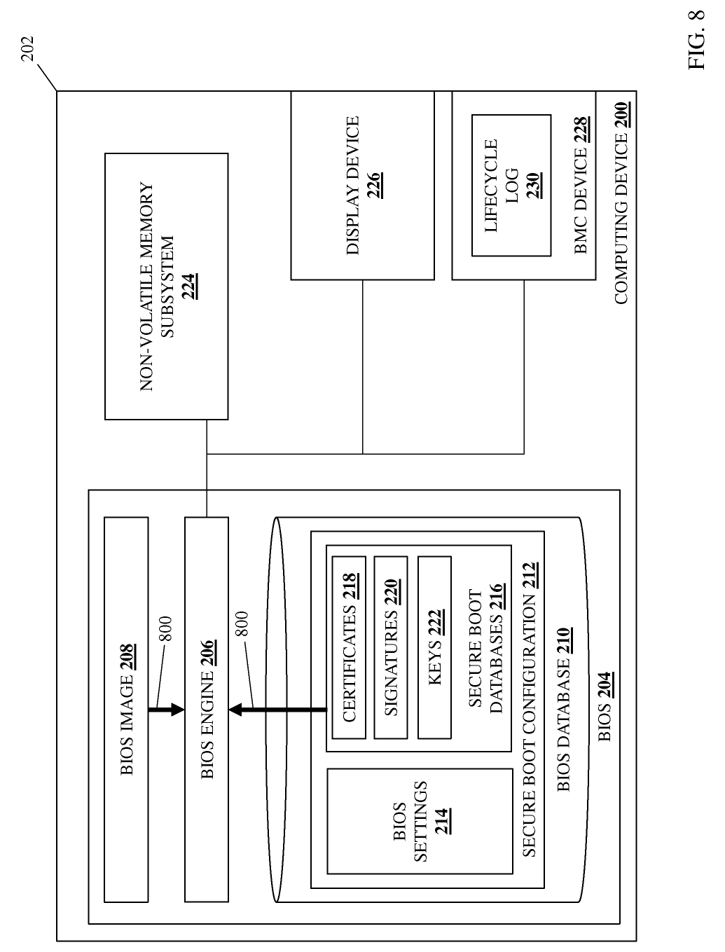

With reference to FIG. 8, in an embodiment of decision block 310, the BIOS engine 206 in the BIOS 204 may then perform secure boot configuration component authentication information modification detection operations 800 that may include identifying component authentication information included in the BIOS image 208, and comparing the component authentication information in the BIOS image 208 to component authentication information included in the secure boot databases 216 to determine whether the component authentication information included in the BIOS image 208 modifies component authentication information included in the secure boot databases 216. For example, prior to the “current” initialization of the computing device 200, the BIOS image 208, a BIOS firmware volume in the BIOS image 208, and/or component authentication information included in the BIOS firmware volume in the BIOS image 208 may be updated (e.g., as part of an BIOS update being performed for the BIOS 204) such that the BIOS image 208, the BIOS firmware volume in the BIOS image 208, and/or component authentication information included in the BIOS firmware volume in the BIOS image 208 provides a modification to component authentication information that is stored in the secure boot databases 216 in the secure boot configuration 212 for the BIOS 204.

To provide a specific example, the BIOS image 208 may be updated as part of the BIOS update described above such that it includes one or more certificates that have been provided for use by the BIOS 204 in place of (or in addition to) one or more of the certificates 218 that are stored in the secure boot databases 216 in the secure boot configuration 212 for the BIOS 204 (e.g., WINDOWS® UEFI CA 2023 certificates, MICROSOFT UEFI CA 2023 certificates, MICROSOFT® Option ROM UEFI CA 2023 certificates, and/or MICROSOFT® Corporation KEK 2K CA 2023 certificates that have been provided for use by the BIOS 204 in place of (or in addition to) older secure boot certificates (e.g., MICROSOFT® WINDOWS® PCA 2011 certificates, MICROSOFT® UEFI CA 2011 certificates, and MICROSOFT® Corporation KEK CA 2011 certificates that will expire in 2026 as described above). As such, at decision block 310, the BIOS engine 206 may determine whether the BIOS image 208 includes one or more certificates that modify the component authentication information in secure boot databases 216 in the secure boot configuration 212 for the BIOS 204 via their addition to the secure boot databases 216.

To provide another specific example, the BIOS image 208 may be updated as part of the BIOS update described above such that it includes one or more signatures (e.g., hash values and/or other signatures known in the art) that have been provided for use by the BIOS 204 in a revoked signatures database (e.g. a “DBX” database) that is included in the secure boot databases 216 to prevent to use of corresponding software components that are not trusted, subject to security vulnerabilities, subject to stability issues, and/or that should otherwise not be allowed to run on or with the computing device 200. As such, at decision block 310, the BIOS engine 206 may determine whether the BIOS image 208 includes one or more signatures that modify the secure boot databases 216 in the secure boot configuration 212 for the BIOS 204 via their addition to the secure boot databases 216. However, while two specific examples have been provided, one of skill in the art in possession of the present disclosure will appreciate how component authentication information in secure boot databases in a secure boot configuration for a BIOS may be modified in a variety of manners (e.g., the BIOS image may provide for the replacement, removal, etc., of certificates, signatures, and/or keys from those secure boot databases) while remaining within the scope of the present disclosure as well.

If, at decision block 310, the BIOS image does not provide a modification to component authentication information in the secure boot configuration, the method 300 proceeds to block 312 where the BIOS subsystem completes the initialization of the computing device. In an embodiment, at block 312, the BIOS 204 may complete the “current” initialization of the computing device 200, and one of skill in the art in possession of the present disclosure will appreciate how the “completion” of the “current” initialization of the computing device 200 may differ depending on whether an “unexpected” secure boot configuration modification message was generated at block 306.

Furthermore, if an “unexpected” secure boot configuration modification message was generated at block 306, the “completion” of the “current” initialization of the computing device 200 may differ depending on a response by the network administrator or other users to an “unexpected” secure boot configuration modification message generated at block 306, a BIOS/computing device policy for responding to an “unexpected” secure boot configuration modification message generated at block 306, and/or based on any other factors that would be apparent to one of skill in the art in possession of the present disclosure.

As such, in some examples the completion of the “current” initialization of the computing device 200 after an “unexpected” secure boot configuration modification message was generated at block 306 may include loading an operating system for the computing device 200 and allowing the computing device 200 to begin runtime operations in which the operating system controls the computing device 200 (e.g., when the “unexpected” secure boot configuration modification was provided, authorized by, or otherwise intended by a network administrator or other user), while in other examples the completion of the “current” initialization of the computing device 200 after an “unexpected” secure boot configuration modification message was generated at block 306 may include providing the computing device 200 in a “safe mode”, ending the initialization operations prior to allowing the computing device 200 to begin the runtime operations discussed above, quarantining the computing device 200, and/or performing any other “unexpected” secure boot configuration modification response operations that one of skill in the art in possession of the present disclosure would recognize as being performed in response to an unexpected change in the secure boot configuration of the BIOS 204 (e.g., when the “unexpected” secure boot configuration modification was not provided by, authorized, or otherwise intended by a network administrator or other user).

However, in embodiments in which no “unexpected” secure boot configuration modification message was generated at block 306, at decision block 310, the BIOS engine 206 in the BIOS 204 may determine that the BIOS image 208 does not provide modifications to the component authentication information in the secure boot configuration 212 for the BIOS 204 and, in response, may complete the “current” initialization of the computing device 200 at block 312by loading an operating system for the computing device 200 and allowing the computing device 200 to begin runtime operations in which the operating system controls the computing device 200.

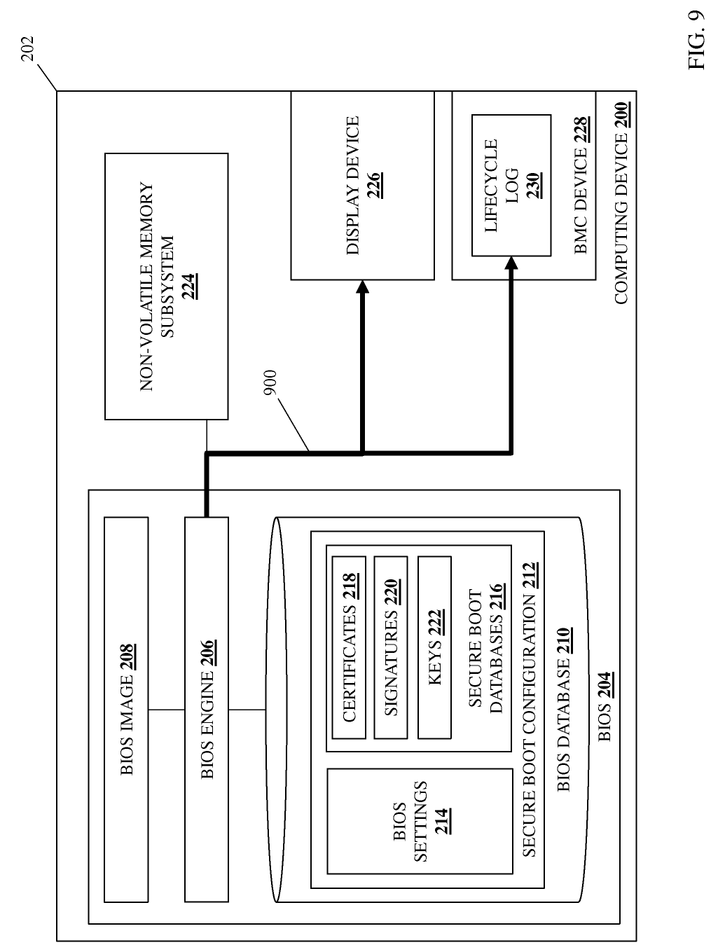

If, at decision block 310, the BIOS image provides a modification to component authentication information in the secure boot configuration, the method 300 proceeds to block 314 where the BIOS subsystem generates an expected secure boot configuration modification message. In an embodiment, at decision block 314, the BIOS engine 206 in the BIOS 204 may determine that the BIOS image 208 provides modifications to the component authentication information in the secure boot configuration 212 for the BIOS 204 and, in response, may generate an “expected” secure boot modification message. With reference to FIG. 9, in an embodiment of block 314, the BIOS engine 208 in the BIOS 204 may perform “expected” secure boot configuration modification message generation operations 900 that may include generating an “expected” secure boot configuration modification message that may be displayed on the display device 226, provided in the lifecycle log 230 included in the BMC device 228, and/or transmitted to a network administrator or other user using any techniques that would be apparent to one of skill in the art in possession of the present disclosure.

In a specific example, the “expected” secure boot configuration modification message may be provided by any informational message that identifies the “expected” secure boot configuration modification and informs the network administrator or other user that the modification detected for the secure boot configuration 216 is expected (e.g., “The recent BIOS update includes new certificates that modify the secure boot configuration. This is an intentional modification”), although one of skill in the art in possession of the present disclosure will appreciate how other “expected” secure boot configuration modification messages will fall within the scope of the present disclosure as well. As will be appreciated by one of skill in the art in possession of the present disclosure, the “expected” secure boot configuration modification message generated at block 314 may be configured to prevent causing a network administrator or other user any alarm (i.e., as compared to the “unexpected” secure boot configuration modification messages described above), and is intended to inform the user of the modification to the secure boot configuration in a manner that prevents (or reduces) the customer support calls discussed above.

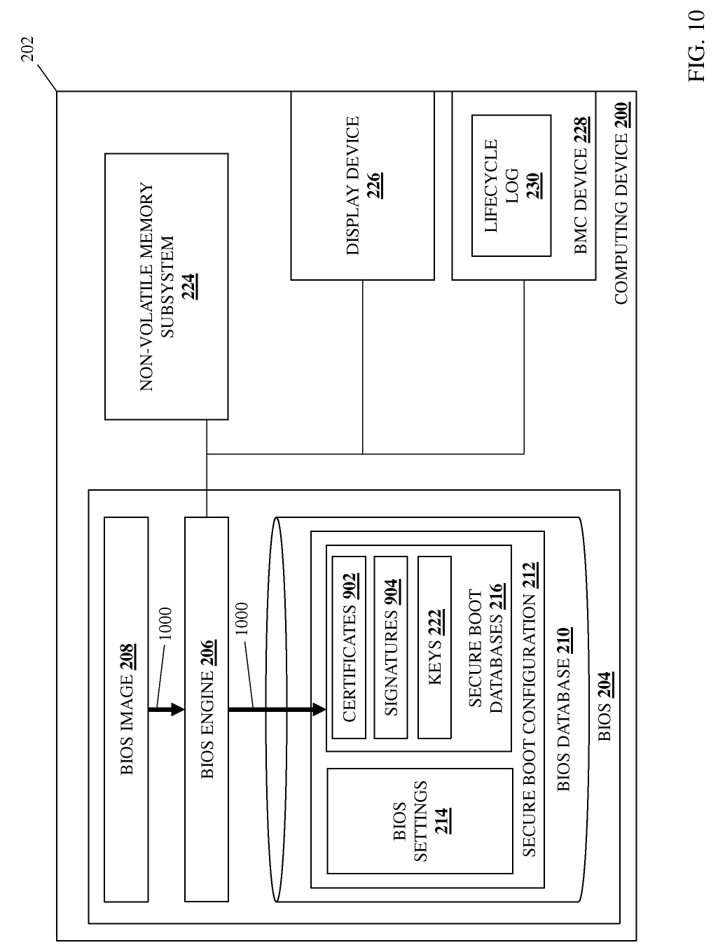

The method 300 then proceeds to block 316 where the BIOS subsystem modifies the component authentication information in the secure boot configuration to provide a modified secure boot configuration. With reference to FIG. 10, in an embodiment of block 316, the BIOS engine 206 in the BIOS 204 may perform component authentication information modification operations 1000 (e.g., as part of BIOS update operations) that may include using the BIOS image 208, a BIOS firmware volume in the BIOS image 208, and/or component authentication information included in the BIOS firmware volume in the BIOS image 208 to modify the component authentication information in the secure boot databases 216 included in the secure boot configuration 216 and provide a modified secure boot configuration 212, which is illustrated and described below as being modified by providing certificates 902 in place or (or in addition to) the certificates 218 discussed above, and providing signatures 904 in place or (or in addition to) the signatures 220 discussed above.

However, while a specific example is provided, one of skill in the art in possession of the present disclosure will appreciate how component authentication information in the secure boot configuration 212 for a BIOS may be modified in any of a variety of manners that will fall within the scope of the present disclosure as well. Furthermore, block 316 of the method 300 is performed subsequent to the performance of decision block 304 in order to ensure that any intended modifications to the secure boot configuration 212 in the BIOS 204 that may be provided by the BIOS image 208 (e.g., the BIOS updates that modify certificates or signatures in the secure boot databases 216 as described above) are not detected as “unexpected” secure boot configuration modifications at decision block 304.

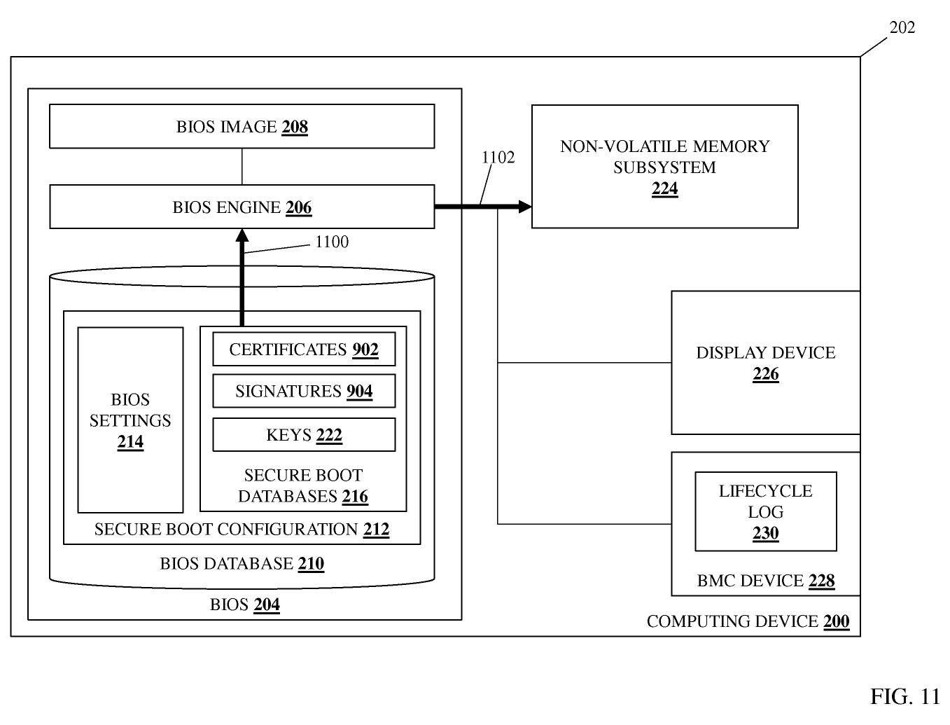

The method 300 then proceeds to block 318 where the BIOS subsystem uses the modified secure boot configuration to generate an initialization hash value update. With reference to FIG. 11, as part of the “current” initialization of the computing device 200 and subsequent to modifying the component authentication information in the secure boot configuration 212 at block 316, the BIOS engine 206 in the BIOS 204 may perform initialization hash value generation operations 1100 that may include performing a hashing operation (e.g., a SHA hashing operation and/or other hashing operations known in the art) using information stored in the secure boot configuration 212 to generate an initialization hash value update that may provide the previous initialization hash value discussed above in a subsequent iteration of the method 300 and during a subsequent initialization of the computing device 200. As such, one of skill in the art in possession of the present disclosure will appreciate how the initialization hash value update may be generated at block 318 using information in the BIOS settings 214; the certificates 902, signatures 904, and keys 222 in the secure boot databases 216; and/or any other information that one of skill in the art in possession of the present disclosure will recognize may be included in the secure boot configuration 212.

The method 300 then proceeds to block 320 where the BIOS subsystem updates the previous initialization hash value with the initialization hash value update. With continued reference to FIG. 11, in an embodiment of block 320, the BIOS engine 206 may perform initialization hash value update operations 1102 that include storing the initialization hash value update generated at block 320 in the non-volatile memory subsystem 224 in place of the “previous” initialization hash value discussed above (i.e., deleting the “previous” initialization hash value from the non-volatile memory subsystem 224, and storing the initialization hash value update generated at block 320 in its place in the non-volatile memory subsystem 224). As will be appreciated by one of skill in the art in possession of the present disclosure, the initialization hash value update may then become the “previous” initialization hash value such that it may be utilized similarly as discussed above in a subsequent iteration of the method 300 and during a subsequent initialization of the computing device 200. As will be appreciated by one of skill in the art in possession of the present disclosure, the replacement of the “previous” initialization hash value with the initialization hash value update generated at block 320 in the non-volatile memory subsystem 224 operates to “mask” the modification performed at block 316 of the secure boot configuration 212 in the BIOS 204 from the secure boot configuration modification detection procedure performed at decision block 304 of the subsequent iteration of the method 300 (i.e., during the subsequent initialization of the computing device 200).

The method 300 then proceeds to block 312 where the BIOS subsystem completes the initialization of the computing device similarly as described above. In an embodiment, the BIOS engine 206 in the BIOS 204 may complete the “current” initialization of the computing device 200 at block 308, and one of skill in the art in possession of the present disclosure will appreciate how the “completion” of the “current” initialization of the computing device 200 in this context (i.e., when only an “expected” secure boot configuration modification has been identified) may include loading an operating system for the computing device 200 and allowing the computing device 200 to begin runtime operations in which the operating system controls the computing device 200.

Thus, systems and methods have been described that distinguish between expected and unexpected modifications to a secure boot configuration in a BIOS and generate an expected secure boot configuration modification message when expected modifications to the secure boot configuration are identified. For example, the BIOS secure boot configuration modification reporting system of the present disclosure may include a computing device housing a non-volatile memory subsystem coupled to a BIOS having a BIOS database that stores a secure boot configuration. During a current initialization of the computing device, the BIOS uses the secure boot configuration to generate a current initialization hash value, determines whether the current initialization hash value matches a previous initialization hash value in the non-volatile memory subsystem that was generated using the secure boot configuration during a previous initialization of the computing device and, if not, generates an unexpected secure boot configuration modification message. If the current initialization hash value matches the second initialization hash value, the BIOS determines that a BIOS image included in the BIOS provides a modification to component authentication information included in the secure boot configuration and, in response, generates an expected secure boot configuration modification message. As such, expected modifications to a secure boot configuration in a BIOS may be identified to users to reduce customer support calls, frequent changes to the code and configuration of the BIOS by the BIOS development team (also referred to as “churn”), and other related issues discussed above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Basic Input/Output System (BIOS) secure boot configuration modification reporting system, comprising:
a computing device;
a non-volatile memory subsystem that is housed in the computing device; and
a Basic Input/Output System (BIOS) that is housed in the computing device, that is coupled to the non-volatile memory subsystem, and that includes:
a BIOS database storing a secure boot configuration; and
a BIOS subsystem that is coupled to the BIOS database and that is configured, during a first initialization of the computing device, to:
generate, using the secure boot configuration, a first initialization hash value;
determine whether the first initialization hash value matches a second initialization hash value that is stored in the non-volatile memory subsystem and that was generated using the secure boot configuration during a second initialization of the computing device that was performed prior to the first initialization of the computing device;
generate, in response to determining that the first initialization hash value does not match the second initialization hash value, an unexpected secure boot configuration modification message;
determine, in response to determining that the first initialization hash value matches the second initialization hash value, that a BIOS image included in the BIOS provides a modification to component authentication information included in the secure boot configuration; and
generate, in response to determining that the BIOS image provides a modification to component authentication information included in the secure boot configuration, an expected secure boot configuration modification message.

2. The system of claim 1, wherein the generation of the expected secure boot configuration modification message provides at least one of:
the display of the expected secure boot configuration modification message on a display device; and
the inclusion of the expected secure boot configuration modification message in a log.

3. The system of claim 1, wherein the component authentication information includes at least one of a component authentication certificate and a component authentication signature.

4. The system of claim 1, wherein the BIOS subsystem is configured, during the first initialization of the computing device, to:
modify, subsequent to generating the first initialization hash value using the BIOS image that provides the modification to the component authentication information included in the secure boot configuration, the component authentication information included in the secure boot configuration to provide a modified secure boot configuration;
generate, using the modified secure boot configuration, a third initialization hash value; and
replace the second initialization hash value that is stored in the non-volatile memory subsystem with the third initialization hash value.

5. The system of claim 1, wherein the secure boot configuration includes a plurality of secure boot databases and a plurality of BIOS settings.

6. The system of claim 5, wherein the BIOS image provides a modification to the component authentication information included in at least one of the plurality of secure boot databases.

7. An Information Handling System (IHS), comprising:
a processing system; and
a memory system that is coupled to the processing system and that includes instructions that, when executed by the processing system, cause the processing system to provide a Basic Input/Output System (BIOS) engine that is configured, during a first initialization of the IHS, to:
generate, using a secure boot configuration, a first initialization hash value;
determine whether the first initialization hash value matches a second initialization hash value that is stored in a non-volatile memory subsystem coupled to the processing system and that was generated using the secure boot configuration during a second initialization of the IHS that was performed prior to the first initialization of the IHS;
generate, in response to determining that the first initialization hash value does not match the second initialization hash value, an unexpected secure boot configuration modification message;
determine, in response to determining that the first initialization hash value matches the second initialization hash value, that a BIOS image included in the BIOS provides a modification to component authentication information included in the secure boot configuration; and
generate, in response to determining that the BIOS image provides a modification to component authentication information included in the secure boot configuration, an expected secure boot configuration modification message.

8. The IHS of claim 7, wherein the generation of the expected secure boot configuration modification message provides at least one of:
the display of the expected secure boot configuration modification message on a display device; and
the inclusion of the expected secure boot configuration modification message in a log.

9. The IHS of claim 7, wherein the component authentication information includes at least one of a component authentication certificate and a component authentication signature.

10. The IHS of claim 7, wherein the BIOS engine is configured, during the first initialization of the computing device, to:
modify, subsequent to generating the first initialization hash value using the BIOS image that provides the modification to the component authentication information included in the secure boot configuration, the component authentication information included in the secure boot configuration to provide a modified secure boot configuration;
generate, using the modified secure boot configuration, a third initialization hash value; and
replace the second initialization hash value that is stored in the non-volatile memory subsystem with the third initialization hash value.

11. The IHS of claim 7, wherein the secure boot configuration includes a plurality of secure boot databases and a plurality of BIOS settings.

12. The IHS of claim 11, wherein the BIOS image provides a modification to the component authentication information included in at least one of the plurality of secure boot databases.

13. The IHS of claim 11, wherein the plurality of secure boot databases include a signatures database, a revoked signatures database, and a Key Exchange Key (KEK) database.

14. A method for reporting modifications to a secure boot configuration in a Basic Input Output System (BIOS), comprising:
generating, by a Basic Input/Output System (BIOS) subsystem during a first initialization of a computing device and using a secure boot configuration, a first initialization hash value;
determining, by the BIOS subsystem during the first initialization of the computing device, whether the first initialization hash value matches a second initialization hash value that is stored in a non-volatile memory subsystem that is coupled to the processing system and that was generated using the secure boot configuration during a second initialization of the IHS that was performed prior to the first initialization of the IHS, wherein the BIOS subsystem is configured to generate an unexpected secure boot configuration modification message in response to determining that the first initialization hash value does not match the second initialization hash value;
determining, by the BIOS subsystem during the first initialization of the computing device in response to determining that the first initialization hash value matches the second initialization hash value, that a BIOS image provides a modification to component authentication information included in the secure boot configuration; and
generating, by the BIOS subsystem during the first initialization of the computing device in response to determining that the BIOS image provides a modification to component authentication information included in the secure boot configuration, an expected secure boot configuration modification message.

15. The method of claim 14, wherein the generation of the expected secure boot configuration modification message provides at least one of:
the display of the expected secure boot configuration modification message on a display device; and
the inclusion of the expected secure boot configuration modification message in a log.

16. The method of claim 14, wherein the component authentication information includes at least one of a component authentication certificate and a component authentication signature.

17. The method of claim 14, further comprising:
modifying, by the BIOS subsystem during the first initialization of the computing device subsequent to generating the first initialization hash value using the BIOS image that provides the modification to the component authentication information included in the secure boot configuration, the component authentication information included in the secure boot configuration to provide a modified secure boot configuration;
generating, by the BIOS subsystem during the first initialization of the computing device using the modified secure boot configuration, a third initialization hash value; and
replacing, by the BIOS subsystem during the first initialization of the computing device, the second initialization hash value that is stored in the non-volatile memory subsystem with the third initialization hash value.

18. The method of claim 14, wherein the secure boot configuration includes a plurality of secure boot databases and a plurality of BIOS settings.

19. The method of claim 18, wherein the BIOS image provides a modification to the component authentication information included in at least one of the plurality of secure boot databases.

20. The method of claim 18, wherein the plurality of secure boot databases include a signatures database, a revoked signatures database, and a Key Exchange Key (KEK) database.
